(19) United States
(12) Patent Application Publication
(10) Pub. No.: US 2023/0200956 A1
(43) Pub. Date: Jun. 29, 2023

(54) DENTAL FLOSS PRODUCT AND METHOD OF MANUFACTURE

(71) Applicant: Genet Kebede Keben, Fredericksburg, VA (US)

(72) Inventor: Genet Kebede Keben, Fredericksburg, VA (US)

(21) Appl. No.: 18/171,342

(22) Filed: Feb. 18, 2023

(30) Foreign Application Priority Data
Feb. 1, 2021 (FI) 20217024
Nov. 24, 2021 (WO) PCT/FI2021/050802

(51) Int. Cl. A61C 15/04

(52) U.S. Cl. CPC A61C 15/046; A61C 15/043

(57) ABSTRACT

The invention relates to a dental floss product and its manufacturing method. The dental floss product consists of a dental floss comprising an operating part for cleaning tooth gaps and two end portions with a gripping surface connected by a joining zone, the first end part being fixed to the first end of the dental floss and the second end is attached to the other end of the dental floss. The ends of the dental floss are permanently fixed around the end portions in the same direction of rotation, and the portion of the dental floss, which extends around the joining zone of the end portions, in the same or opposite direction of rotation. The dental floss is attached to the plate web by rotating it around its longitudinal axis or by rotating the dental floss around the plate web.

The object of the invention is a dental floss product and its method of manufacturing as set out in patent claims 1 and 2 in the preamble.

### BACKGROUND OF THE INVENTION

If the interdental spaces are not cleaned regularly, food and bacteria will accumulate in them, causing gingivitis, cavities, and tartar and plaque formation, among other things. Food left in the gaps can also cause pain. The gaps must therefore be cleaned regularly. Cleaning the interdental spaces does not work well enough with a toothbrush.

There are various products for cleaning the teeth cap. One known solution is toothpicks. Penetration of a toothpick between teeth may also cause momentary pain and possibly also prolonged pain, and food may not come out between the molars.

Another known solution is dental floss. The dental floss is usually packed in a package where there are tens of meters into a solid roll inside a plastic case, the case of which is additionally equipped with a cutter. The user can use the cutter to cut the dental floss. One problem is the availability of dental floss when needed. Few carry the entire dental floss package with them. Another problem is cutting the right length of floss with the cutter included in the package. The third problem is holding the slippery dental floss and the caused pain in the fingers around which the dental floss is wound. Another problem with commonly used dental floss is that its case is not biodegradable.

One known solution for cleaning interdental spaces is dental floss product, which is usually plastic and therefore neither bio-degradable nor ecological. A further problem with dental floss products is that the dental floss between the arcs is not tensioned tightly enough, making it difficult to get the floss between the teeth. The wire also stretches, and the plastic arch stretches easily. In addition, when the floss slips between the teeth, the ends of the plastic arch often strike the gums or the skin of the cheek, causing pain or, at worst, a wound. In addition, putting a plastic arc in your mouth is not yet pleasant. The child's mouth is also too small for these dental floss products.

There are also known to be interdental brushes for cleaning small interdental spaces, plastic brushes suitable for cleaning large interdental spaces, but especially not for cleaning posterior teeth narrow interdental spaces. In addition, when using an interdental brush, the gums begin to bleed easily. Using an interdental brush can also cause momentary pain as well as prolonged pain. Another problem with interdental brushes is poor ecology.

To clean the interdental spaces, there are also known to be electric interdental jets that spray water through the nozzle into the interdental spaces. The problem with this solution is, among other things, that this cleaning method can be used practically only at home and at the dentist. Another problem is that cleaning between the molars is not possible, at least not easily.

There are also patents and patent applications for dental floss products which have attempted to solve the problem of individually packaged dental floss and the problem of gripping the slippery dental floss. These solutions have been left without practical implementation, for which a convenient solution has now been found.

### BRIEF SUMMARY OF INVENTION

The object of the present invention is to eliminate the above-mentioned drawbacks and to provide an easy-to-use, ecological and inexpensive new type of dental floss product. The method of manufacturing a dental floss product according to the invention is characterized by what is outlined in the characterizing part of claim 1. Other embodiments of the invention are characterized by what is stated in the other claims.

For the dental floss product formed by the manufacturing method according to the invention is characteristic that the product comprises one dental floss comprising an operational part for cleaning tooth gaps and two end pieces with a grip surface connected to the dental floss, the first end piece being fixed to the first end of the dental floss and the second end to the other end of the floss. The area of the gripping surfaces of the end pieces is substantially larger than the gripping area of the dental floss so that it is easy to hold the dental floss product when cleaning the tooth gaps.

Another advantage is that the dental floss can also be hygienically packed in individual packages and the individual products can be conveniently transported so that the dental floss is always available when needed. A further advantage of the dental floss product according to the invention is that the product is simple, environmentally friendly, and inexpensive. In this dental floss product, the slippery generally waxed dental floss is reliably attached to the end portions, and the attachment thus also withstands skewing well. This dental floss product can be made by rotating the continuous plate web back and forth and moving the plate web or floss feed point forward between rotations, or by rotating the dental floss with special arrangements around the plate web and moving the plate web or floss feed location forward between rotations.

### BRIEF DESCRIPTION OF THE SEVERAL VIEWS OF THE DRAWING

In the following, the invention will be described in more detail with reference to the accompanying simplified drawings, in which

FIG. 1—shows, in the direction of the gripping surfaces, an unpackaged dental floss product according to one embodiment of the invention before use,

FIG. 2—shows a finished dental floss product without protective package 5, seen from the side after cutting apart from the product web 22,

FIG. 3—shows, from the direction of the gripping surfaces, the unpackaged dental floss product according to FIG. 1, torn in two,

FIG. 4—is a bottom view of the unpackaged dental floss product of FIG. 1,

FIG. 5—shows an elevated view of an embodiment of fastening the dental floss 3 and the plate web 2 according to one embodiment of the invention according to one FIG. 1 by rotating the plate web 2 around it,

FIG. 6—shows a plate web 2 according to one embodiment of FIG. 5, cut from 5-5,

FIG. 7—shows a plate web 2 according to another embodiment of FIG. 5, cut from 5-5,

FIG. 8—shows one wide V-shaped and positional web according to the embodiment of FIG. 1, seen from above, illustrating the principle of rotation of the dental floss 3 around the plate web 2,

FIG. 9—shows a side view of an unpackaged dental floss product according to one embodiment of FIG. 1,

FIG. 10—shows a side view of a packaged dental floss product according to the embodiment of FIG. 17,

FIG. 11—shows a manufacturing method for attaching dental floss 3 to a plate web 2 according to one embodiment of FIG. 1, seen the wide V-shape plate web 2 from above,

FIG. 12—shows a side view of the fastening of the dental floss 3 and the plate web 2 to each other by rotating the plate web 2 according to another embodiment of the invention,

FIG. 13—shows the unpackaged dental floss product of FIG. 12 in cut from 12-12,

FIG. 14—shows the opening of the uncompressed plate web 2 according to one embodiment of FIGS. 3 and 12 as seen from the direction of the gripping surfaces,

FIG. 15—shows, from the direction of the gripping surfaces, a packaged dental floss product according to one embodiment of the invention before use,

FIG. 16—shows, from the direction of the gripping surfaces, the packaged dental floss product of FIG. 15 for use torn in half,

FIG. 17—shows a top view of the packaged dental floss product of FIG. 15,

FIG. 18—shows, in the direction of the gripping surfaces, an unpackaged dental floss product according to one embodiment of the invention before use,

FIG. 19—shows a manufacturing method according to an embodiment for attaching dental floss 3 to a plate web 2 according to FIG. 18, seen from the side,

FIG. 20—shows another manufacturing method according to another embodiment for attaching dental floss 3 to a plate web 2 according to FIG. 18, seen from the side.

### DETAILED DESCRIPTION OF THE INVENTION

FIGS. 1, 2 and 4 show an unpackaged dental floss product 1 according to one embodiment of the invention before the end portions 1a and 1b are separated from each other.

The dental floss product comprises dental floss 3 and plate-like end portions 1a and 1b which are connected by a joining zone 4c. The plate-like end portions are made of, for example, recyclable, and biodegradable cardboard or carton, and the dental floss is candelilla waxed natural silk.

The length of the dental floss product is substantially twice its width and the joining zone 4c is substantially longitudinally from the center of the product. In this application example, the tear line is implemented, for example, by cutting, grooving, or perforating, but leaving the bottoms of the notches 2e intact in the joining zone for the rotation of the dental floss 3. The plate-like dental floss product can be easily cut into two separate parts at the joining zone 4c. Dental floss 3 is attached to the fastening zones 4a and 4b of the end portions 1a and 1b, and the dental floss operational portion is stored in the joining zone 4c. The dental floss leaves the fastening zones 4a and 4b inside the end portions 1a and 1b and in the middle thereof towards the joining zone 4c as seen from the joining zone 4c. The dental floss 3 is preferably fixed in the middle of the end portions 1a and 1b, using cuts as shown in the figure up to the middle of the end portions 1a and 1b. The cut may, of course, be a groove or the like and there may be a hole in the bottom of the cut through which the dental floss 3 passes through the end portion. Cutting lines 19a and 19b show the places in which the dental floss products are cut apart from each other.

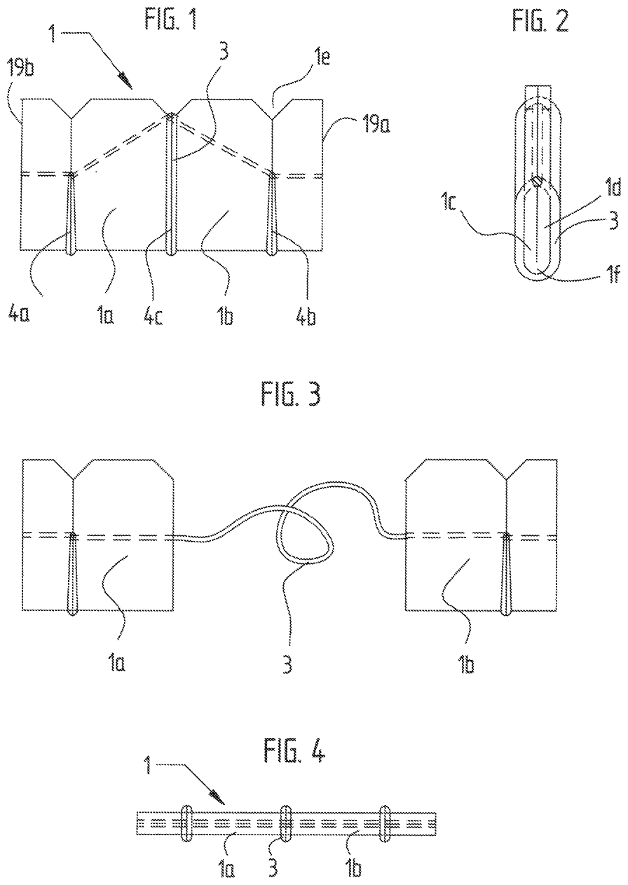

FIG. 2 together with FIG. 1 shows a folded plate 1 having sides 1c and 1d, their joint 1f, how the dental floss 3 is arranged around folded plate 1, and how it passes between the sides 1c and 1d from notch 1e to the next one. The dental floss 3 can rotate the folded plate 1 in one or two directions as explained in FIGS. 11, 19, and 20, keeping the sides 1c and 1d against each other or at least the parts under the dental floss (3).

FIG. 3 shows the dental floss product of FIG. 1 cut in half. The dental floss product is divided into two separate plate-like end portions 1a and 1b, i.e. the gripping surfaces or the holding member, by tearing the dental floss product open at the joining zone 4c, i.e. the tear line. When the dental floss product is divided in this way into two end portions 1a and 1b and the end portions are pulled apart, the dental floss 3 is stored at the tear line, or more precisely its operational portion with which the tooth gaps are to be cleaned is released. Dental floss 3 is further, at its ends, rotated around the end portions 1a and 1b, which are provided with gripping surfaces having an area substantially larger than the gripping surface of dental floss 3. The dental floss product is now in its operating state, in which the product has two spaced-apart end portions 1a and 1b, between which there is a dental floss 3 operating portion with which the user can clean his tooth gaps. When the user cleans his tooth spaces with dental floss 3, he holds on to the end portions 1a and 1b, whereby the cleaning of the tooth spaces is successful and easy, without the problems described in the general part of the application. The end portions 1a and 1b are easy to hold and the tensioning of the dental floss 3, i.e. the adjustment of the tension to suit, is also easy and requires less compressive force than, for example, when using ordinary dental floss. Both end portions 1a and 1b are held, for example, with fingers and/or palms. In this case, the grip of the end portions 1a and 1b is a compression grip caused by fingers and/or the palm. The gripping surface, i.e. the gripping area of the end portions 1a and 1b, is substantially larger than the gripping surface when using conventional dental floss. Dental floss 3 is also easy to fit in the tooth gaps.

The operating part of the dental floss 3 has a length of 5-20 cm, preferably 7-13 cm.

In addition, dental floss 3 may contain flavors and/or fragrances, teeth whitening, fluorinating, abrasive, and/or cold/hot tenderness-reducing agents.

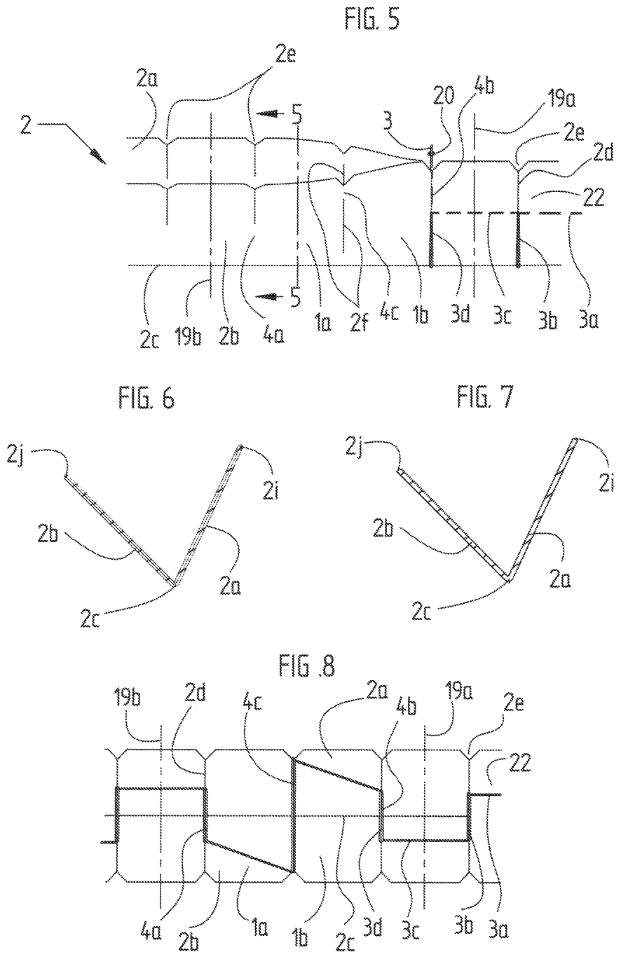

FIG. 5 shows a plate web 2 consisting of two sides 2a and 2b and a connecting point 2c connecting them, as well as one continuous dental floss 3 rotated around it, which is illustrated by its parts 3a, 3b, 3c, 3d.

The plate web has cuts 2d which extend in its sides 2a and 2b from above, preferably up to the middle of the sides 2a and 2b. The dental floss fastening zones 4a and 4b have notches 2e to guide the dental floss 3 into the cuts 2d and the joining zone 4c has a cut 2f which facilitates the tearing of the finished dental floss product into two end portions 1a and 1b. The cutting line 19, illustrated by lines 19a and 19b, preferably in the middle of the notch 2e division, are the places where the dental floss product is cut from the product web 22 resulting from joining the plate web 2 and the floss 3 at the end of the production line packed, unpackaged, or cut by the customer.

Part of the dental floss 3a runs between the sides 2a and 2b of the plate web 2 from the left to the horizontal section 2d.

Part of the dental floss 3b passes around the sides 2a and 2b through the base of the cuts 2d therein and the connecting point 2c connecting them clockwise from the dental floss section 3a for a predetermined full number of turns, thus the part of the dental floss 3b is permanently attached to the plate web 2 and the sides 2a and 2b are against each other.

The dental floss portion 3c extends between sides 2a and 2b at the dental floss 3 guide ring 20.

Plate web 2 has in the previous step just been rotated about a horizontal axis running approximately at the floss portion 3a, preferably clockwise, the number of turns of the floss counterclockwise around the sides 2a and 2b of plate web 2 is the same number of turns as the previous time, at the previous cut 2d. When rotating, the floss portion 3d is guided by the floss guide ring 20 and the notches 2e of the sides 2a and 2b to the cut 2d under the floss guide 20. Thus, on the fastening zone 4b, the dental floss portion 3d extends around the sides 2a and 2b counterclockwise, i.e. in the opposite direction to the dental floss portion 3b. It is supported on the bottom of the cuts 2d of the sides 2a and 2b and on the joint 2c of the sides, whereby the sides 2a and 2b of the plate web 2 are pressed against each other by the tension of the dental floss 3 held tautly.

Plate web 2 is next moved to the right in the direction of the dental floss portion 3a by the division of notches 2e, whereby more dental floss 3 slides between the sides 2a and 2b and the joining zone 4c made in the plate web moves to the floss guide ring 20.

Next, plate web 2 is rotated about the same horizontal axis running approximately at the floss portion 3a, preferably counter-clockwise, by the same number of full turns as the previous time. As the dental floss 3 is rotated, guided by the dental floss guide ring 20, the bottom 2a and the connecting point 2c at the joining zone 4c of the sides 2a and 2b are guided and the sides 2a and 2b are pressed against each other by the tensioned dental floss 3.

Thus, the direction of rotation of plate web 2 changes after each plate web 2 is moved forward, whereby at the same number of revolutions the plate web is in a straight, non-rotating state in the middle of the rotations. More dental floss accumulates in the joining zone than in the fastening zones, saving the dental floss material, because the cut 2d preferably continues to the middle of the plate web 2, thus shortening the distance of one circumference. By doing so with the same number of turns, the dental floss 3 securely fastens to the plate web in the fastening zones 4a and 4b so that sufficient dental floss 3 can be stored as its operating part in the joining zone 4c.

The figure also shows how a wide cross-sectional V-shaped plate web 2 turns into an I-shaped unpackaged product web 22 about the sides 2a and 2b of the plate web 2 or at least part of them is pivoting towards each other when tightened by the dental floss 3.

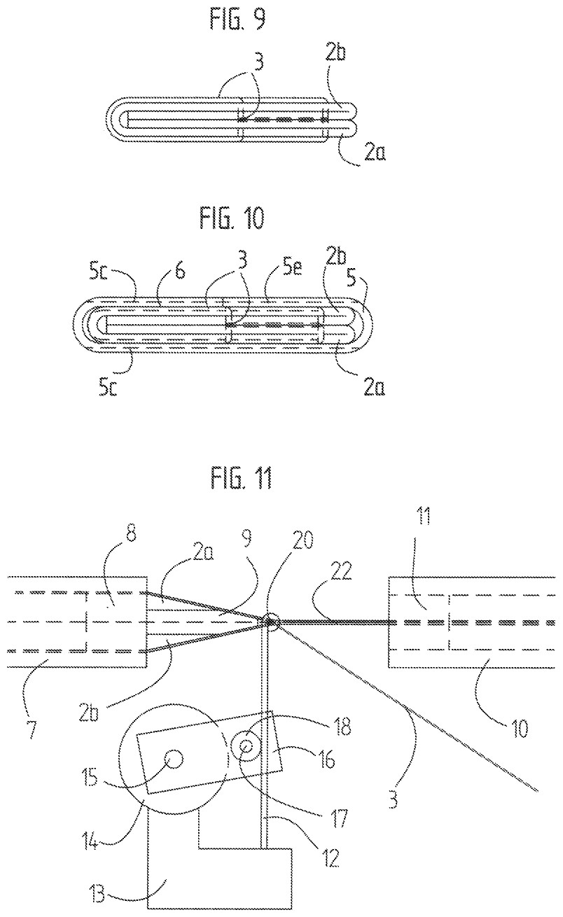

FIG. 6 illustrates a wide V-shaped plate web (2) made of three wide folded V-shaped sides 2a, 2b, their joint 2c, and outer edges 2i and 2j, cut from position 5 shown in FIG. 5. The sides 2a and 2b of plate web 2 consists of two inwardly folded portions, the edges of which meet at junction 2c. It is advisable to make plate web 2 from a thinner, and wider cardboard web with snapped folds, as can also be seen in FIG. 9, because the narrow cardboard web cannot be obtained as a roll.

FIG. 7 illustrates a wide V-shaped plate web 2 folded only once from plate portions 2a and 2b. It has the joint 2c and the outer edges 2i and 2j, shown in section 5 in FIG. 5.

FIG. 8 illustrates the principle of how dental floss 3 rotates step by step the plate web 2 formed by the sides 2a and 2b and the joint 2c when it is preferably rotated back and forth in the same way in complete revolutions and moved to the right between the rotations in steps of the division of the notches 2e. For example, at the marked notch 2e, the dental floss portion 3b is rotated about the plate web 2 clockwise as viewed from the direction of the dental floss portion 3a.

FIG. 9 illustrates an unpackaged dental floss product. According to a preferred embodiment of the invention, no protective package 5 is added to the unpackaged product floss product 22 of FIG. 9. This floss product is suitable for home use. Also in this embodiment the dental floss 3 moves from the end portions 1a and 1b to their joining zone 4c, preferably between the sides 2a and 2b of the plate web 2, in the middle thereof, the end portions 1a and 1b not turning when 3 when tightening. This dental floss product can be detached from the product web 22 already in manufacture or the consumer buys the product without packaging, for example in pieces of a certain length, for example, folded preferably in a separate cardboard box or rolled in a separate cardboard package with a dental floss extraction hole. Thus, a cut 2f must be placed in cutting line 19 of FIG. 5 to cut the dental floss 3 of the unpackaged product web 22 and, if desired, add notches 2e to the cutting line 19 to facilitate removal of this unpackaged dental floss product from the plate web 22 by a consumer.

FIG. 10 shows a finished packaged dental floss product according to FIGS. 3 and 9 placed in a separate protective package 5, preferably made of cardboard. According to one embodiment, the sides 2a and 2b of the plate web 2, the dental floss 3, the mutual crease 5e made in the splicing zone 5c, protective package 5, and the adhesive 6 are shown in the figure.

After joining the dental floss 3 and the plate web 2 according to FIG. 5, the still unprotected product web 22, which is illustrated in FIG. 9 from its end, becomes as shown in FIG. 10 as follows:

The product web 22 passes between the press rolls, immersing the dental floss 3 at least in part in the plate web 2. Thereafter, a pre-fold packaging web ns. between the milk glue and the press rolls a protective package 5 is attached around the unprotected product web 22 according to FIG. 9 and the dental floss 3 is at least partially immersed between the press rolls in the protective package 5. By gluing together the product web 22 finally, the finished dental floss product is cut into a separate packaged dental floss product according to FIGS. 10, 15, and 17.

FIG. 11 illustrates how dental floss 3 can be attached around a continuous plate web 2.

Parts 7 and 10 are separate tubular shafts with a dental floss guide ring 20 between them. The tubular shafts are supported by bearings on body 13 of the production line and both are rotated by the same high-speed stepper motor, for example using pulleys and non-slip belts, as if they were the same shaft. A nozzle 8 is attached to the front of the hole in the tubular shaft 7 and has a wide V-shaped hole for the passage of the plate web 2. Correspondingly, nozzle 11 is attached to the front of the hole in the tubular shaft 10 and has an I-shaped hole for the passage of the product web 22 tightened by the dental floss 3. The holes in the nozzles are preferably arranged so that at the guide ring 20 plate web 2 rotates in place and guide ring 20 can thus be very close to the outer circumference of the rotating plate web 2. Plate web 2 continues through the tubular shaft 7 and at some distance is attached to the plate web 2 feeder and cannot move. Along the line just before the feeder is the perforation of plate web 2 using the same feeder. The product web 22 continues through the tubular shaft 10 and at some distance is prevented from rotating about its longitudinal axis. The plate web 2 and the product web 22 rest on their nozzles 8 and 11 but are allowed to slide inside them. The material passing through plate web 2 into product web 22 has tensile stress caused by a tensioning roller hanging on product web 22 on the side of the tubular shaft 10 after the anti-rotation.

Part 9 is a slider that keeps the outer edges of sides 2a and 2b of plate web 2 slightly apart when plate web 2 is moved to the right by the division of notches 2e. An alternative to a separate slide is the preferred design of nozzle 8.

When moved, dental floss 3 can slide between sides 2a and 2b, even though the floss portion 3d is already in place, as shown in FIG. 5, guided by guide ring 20 of the dental floss 3. Part 12 is, for example, a spring wire with a guide ring 20 of the dental floss 3 at the end. Attached to shaft 15 of the adjusting stepper motor 14 is a cam 16 having a shaft 17 attached thereto and a bearing 18 abutting a spring wire 12 therein.

Before starting the actual web back-and-forth rotation, it is ensured that the web combination is not twisted and that the pair of notches 2e is at the guide ring of the floss 3 and the end of the floss 3 is manually fixed to the plate web 2 in a predetermined direction to provide sufficient holding force. Next, plate web 2 is programmatically rotated by a fast rotary stepper motor, preferably in a direction that increases the rotations of the dental floss 3 around plate web 2 by half the normal number of revolutions. Utilizing the feeder using the third stepper motor, plate web 2 is moved forward by the division of the notches 2e, and the tensioning roller also pulls product web 22 forward by the same amount. When the dental floss 3 is moved, slider 9 slides open to hold between the sides 2a and 2b of the plate web 2, and the next notch 2e of the plate web 2 moves to the guide ring 20.

Next, the number of normal revolutions is programmatically rotated in the opposite direction to the web assembly, after which the combination of plate web 2 and product web 22 is again programmatically moved forward and continued as described in FIGS. 5 and 8.

Since plate web, 2 slightly lengthens when the rotation about its longitudinal axis in the middle of the rotation disappears and shortens again when the rotation returns, only the longitudinally closed end of the feed web 2 at the guide ring 20 of the plate web 2. This effect of the change can be eliminated by turning the cam 16 during the rotation of the web assembly from the downward position in FIG. 11, with the dental floss guide ring 20 following the notch 2e because the bearing 18 attached to the cam 16 first pushes the spring wire 12 to the right and returns the spring wire. During the next rotation, the cam 16 pivots back upwards.

The stepper motor feeding the plate web 2 can also be used to hold the notches 2e for the dental floss feeding at the position of the guide ring 20 by driving the plate web back with the stepper motor first and then returning to the starting position.

The number of revolutions of the normal rotation of the reciprocating web combination is determined by two factors. First, the attachment of the dental floss 3 to the end portions 1a and 1b must withstand the tensile force when using the dental floss product, and increasing the number of turns increases the holding force between the end portions 1a and 1b and the slippery dental floss 3 to a sufficient extent. Increasing the number of turns also increases the length of the operational portion of the dental floss 3 stored in the joining zone 4c.

If it is desired to use an unpackaged dental floss product cut from the product web 22, a small amount of glue can be added between the sides 2a and 2b at the cut 2d as the fastening zone 4b moves to the floss guide ring 20. In this case, sides 2a and 2b are “one tree” from the bottom to the beginning of section 2d.

The plate web can also be rotated in the same direction of rotation for several successive notches and then the direction of rotation is reversed.

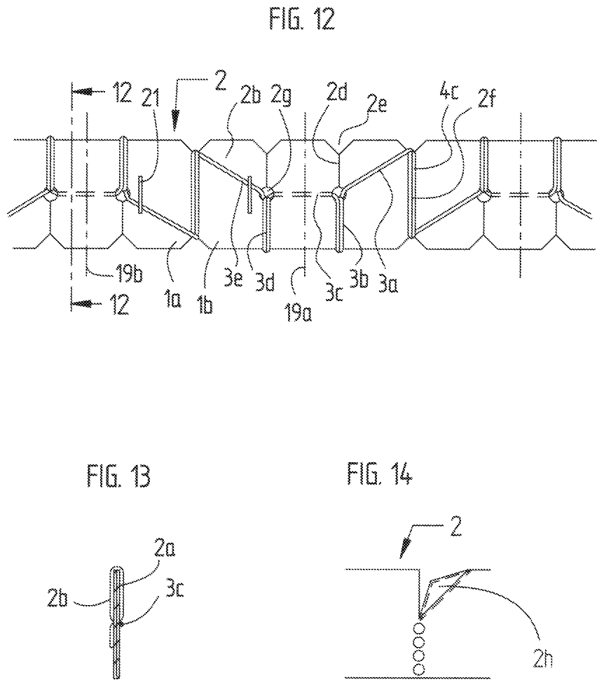

FIGS. 12 and 13 illustrate a web in which the plate portions 2a and 2b are already facing each other before joining the dental floss 3 or only one straight plate web is used. The plate web may also consist of several overlapping sides as in FIG. 9. FIG. 13 shows the dental floss product of FIG. 12 cut from point 12.

By rotating the plate web back and forth, the dental floss 3 can also be attached to the I-shaped web. In this embodiment, holes 2g made in the plate web 2 are preferably used, through which the dental floss parts 3b and 3d pass through the plate web 2 and to which they are attached. From the right, the first rotated dental floss 3 rotates the plate web 2 clockwise from right to left. Since in this solution, the dental floss does not enter the joining zone 4c inside the plate web, it is better to use a separate protective package 5 or to fasten the dental floss 3 to the end portions 1a and 1b, preferably using, for example, a rivet 21.

Alternatively, the rivets can be attached from the top of protective package 5 while also supporting the dental floss 3 against the plate web 2 of the product web 22, whereby the packed end portions 5a and 5b are more resistant to skew when using a dental floss product.

FIG. 14 illustrates a way of connecting the notch 2e and the cut 2d to guide the dental floss 3 in the middle of the plate web. The fold 2h made in the preferred direction straightens as it passes between the rollers after the fixing of the dental floss 3. The solution according to FIG. 14 can also be used to replace notch 2e in the joining zone 4c and the cut 2f can be replaced by perforation.

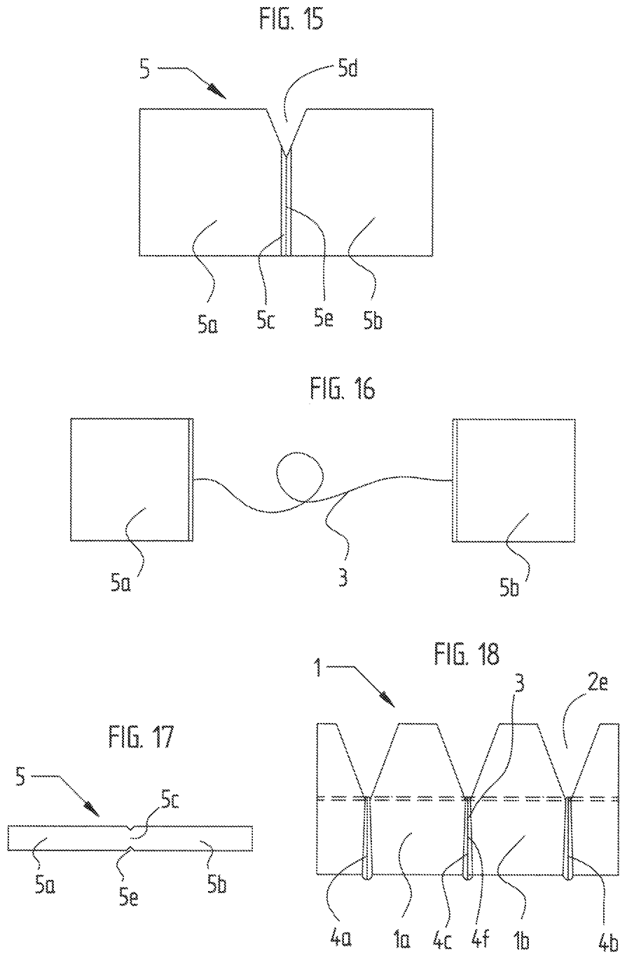

FIGS. 15 and 17 show a packaged dental floss product according to one embodiment of the invention before use. The dental floss product comprises the protective package 5 and, inside it, shielded portions 1a and 1b detached from the product web 22, which are connected by the joining zone 4c below the splicing zone 5c. The packaged dental floss product is divided into two end portions 5a and 5b. Protective package 5 and plate web 2, which are permanently attached, for example by gluing, are made of, for example, recyclable and biodegradable cardboard or carton, if desired moisture-resistant sheet-like and substantially rectangular. A piece of dental floss is tightly and hygienically packed inside the package. The length of the dental floss product is substantially twice its width and the dental floss product is divided into two end portions 5a and 5b substantially longitudinally from the center of the package to which a splicing zone 5c is made, which in this embodiment is a tear line by mutual creasing. The plate-like dental floss product can be easily cut into two separate parts at the splicing zone 5c also by using notch 5d and notch 2e and cut 2f in the plate web 2 below.

The plate-like package may contain, for example, the name of the hotel chain in the bathroom of the hotel room or information about the product. The size of the package is 5-30 mm×10-60 mm preferably 15-20 mm×30-40 mm. The package may have information about the product and/or the color of the package or the number on it may indicate the thickness of the dental floss or the like. Also, the shape and size of protective package 5 can be different from those shown in FIGS. 15, 16 and 17. Shapes of animals and cartoon characters can be used in plate-like packages or protective package 5 can be other than plate-like e.g. a relief or 3D figure when molding, casting or a similar method is used in the manufacturing of protective package 5.

FIG. 16 shows the dental floss product of FIG. 15 cut in half. The dental floss product is divided into two separate plate-like end portions 5a and 5b, i.e. the gripping portion or the holding member, by tearing the dental floss product open at the splicing zone 5c, i.e. the tear line. When the dental floss product is divided in this way into two end portions 5a and 5b and the end portions are pulled apart, the operational portion of the dental floss 3 is packed therein, with which the tooth gaps are to be cleaned, emerges. The dental floss 3 is further attached at its ends to the end portions 5a and 5b provided with gripping surfaces having an area substantially larger than the gripping area of the dental floss 3. The dental floss product is now in its operating state, in which the product has two spaced-apart end portions 5a and 5b, between which there is a dental floss 3 operating portion with which the user can clean his interdental spaces. When the user cleans his tooth gaps with dental floss 3, he holds on to the end portions 5a and 5b, whereby the cleaning of the tooth gaps is successful and easy without the problems described in the general part of the application. It is easy to hold the end parts 5a and 5b and the tensioning of the dental floss 3, i.e. the adjustment of the tension to suit, is also easy and requires less compressive force than, for example, when using ordinary dental floss. Both end portions 5a and 5b are held, for example, with fingers and/or palms. In this case, the grip of the end parts 5a and 5b is a compression grip caused by fingers and/or the palm. The gripping surface, i.e. the gripping area of the end portions 5a and 5b, is substantially larger than the gripping surface when using conventional dental floss. Dental floss 3 is also easy to fit in the tooth gaps.

The end portions 5a and 5b, i.e. the holding members or at least one of them, may also be coated with material allowing good adhesion, preferably with a material with good friction, or the surface may be loose and/or the surface may have bumps or the like so that the holding member slips less when in hand.

FIGS. 15 and 17 show a splicing zone 5c made in protective package 5 of the dental floss product, which is substantially in the width direction of protective package 5 on the center line and substantially the entire width of its dental floss product, preferably, for example, the entire centerline length of the crease 5e or notch 5d only on one or both sides without cutting through the package and thus damaging the underlying dental floss 3. It is also possible to cut a notch 5d at the notch 2e through the whole product.

In the dental floss product, the dental floss 3 in protective package 5 rotates at the splicing zone 5c of the package, preferably in the opposite direction to its attachments to the end portions 5a and 5b. In the end portions, 5a and 5b of protective package 5, the dental floss 3 moves from its attachment points to the splicing zone 5c, preferably inside protective package 5, and the dental floss 3 does not disintegrate when the dental floss product is used. Dental floss 3 is preferably attached from the direction of the splicing zone 5c and also in the width direction of the end portions to their center.

FIG. 18 shows a dental floss product cut from product web 22 without protective package 5.

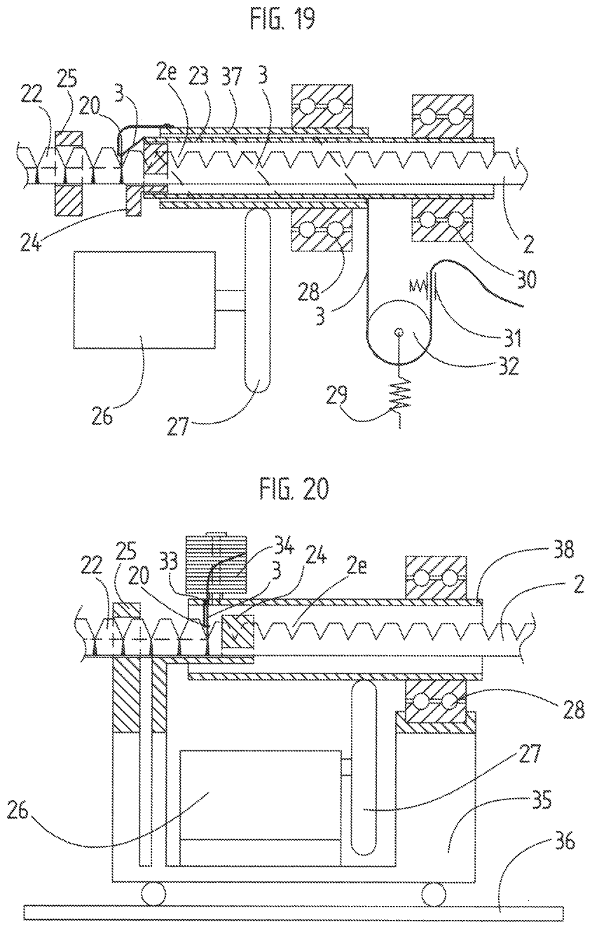

FIG. 19 shows an embodiment of the dental floss product according to FIG. 18 how the dental floss 3 can be rotated around a continuous plate web 2 using two nested tubular shafts 37 and 23 supported on each other by rotating bearings 28 and 30 through which the plate web 2 passes. The guide ring 20 of the dental floss 3 is attached to a tubular shaft 37 which is rotated back and forth using a stepper motor 26 and a friction wheel 27 mounted on the body of the device. The I-shaped non-rotating guide 25 supports the product web 22. The dental floss 3 enters the guide ring 20 between the tubular shafts 37 and 23. In the described solution, the dental floss rotates two and a half times around the tubular shaft 23 and comes out of the end of the tubular shaft 37. The tubular shaft 23 is mounted to rotate freely as it is rotated by the dental floss 3. As the dental floss 3 is fed and the tubular shaft 37 rotates, the guide ring 20 passes through the notches 2e of the plate web 2. When tube shaft 37 stops, guide ring 20 is between the sides 2a and 2b of plate web 2, and as plate web 2 moves forward the dental floss 3 rests immediately on the adjacent side 2a or 2b, depending on the direction. The guide ring 20 bypasses the edges of the notch 2e and the tube shaft 37 is free to rotate five turns in the direction in which part of the dental floss 3 wound around the tube shaft 23 wraps around the plate web 2 and the rest is first returned around the middle of the cycle. At the same time, an amount of new dental floss 3 corresponding to the length of the dental floss 3 wound around the plate web 2 slipped through the brake 31, which is adjusted to the force of the spring 29 and the weight of the tension roller 31.

FIG. 20 shows one embodiment of the dental floss product according to FIG. 18 how a dental floss 3 can be rotated around a continuous plate web 2 by a tubular shaft 38 supported on a movable body 35 by a bearing 28, through which the plate web 2 passes. The guide ring 20 of the dental floss 3 is attached to a tubular shaft 38 which is rotated back and forth or in only one direction using a stepper motor 26 and a friction wheel 27 mounted on the movable body 35 of the device. the I-shaped non-rotating guide 25 attached and to the movable body 35 of the device supports the product web 22. Dental floss 3 enters the guide ring 20 through the tubular shaft 38 through the hole 33 or outside the end of the tubular shaft. The dental floss roll 34 is attached to the tubular shaft 38 and rotates with it around the plate web 2. The dental floss roll 34 rotates about its mounting shaft 37 or the mounting shaft 37 is a tube through which the dental floss 3 is released to the guide ring 33 from the dental floss roll 34 without rotating about the pipe shaft 37. The dental floss rotates around the plate web 3 as in FIG. 19.

Here, as in the solution of FIG. 19, in the manufacturing process, the longitudinal axis of plate web 2 can be advanced either by moving the plate web 2 or by moving the movable body 35 relatives to the fixed body 36 to which the plate web 2 is attached or moving both in opposite directions.

In addition, in both solutions of FIGS. 19 and 20, the parts called tubular shafts 37, 38, and 23 may also be non-tubular parts with which the desired functions are achieved.

FIGS. 1, 2, 3, 4 and 9 show and have described above a preferred embodiment of the invention in which the dental floss product is unpackaged.

Another preferred embodiment of the invention, shown in FIG. 18 and described above in FIGS. 19 and 20, in which the dental floss product is unpackaged. However, the invention can also be implemented in other ways.

A third preferred embodiment of the invention, shown in FIGS. 13 and 12, is in which plate parts 2a and 2b of plate web 2 are already facing each other before the dental floss 3 is connected thereto. FIG. 13 shows the dental floss product of FIG. 12 cut from point 12. It is also possible to use one narrow straight plate web without folds.

By reciprocating the web, the dental floss 3 can also be attached to the I-shaped web. From the right, the first twisted floss rotates the plate web 2 clockwise when viewed from right to left. Since in this solution the dental floss does not come at the joint zone 4 from inside the plate web 2, protective package 5 supports the dental floss in oblique pulling.

In a fourth preferred embodiment of the invention, no packaging is added to the product according to FIGS. 12 and 13, but dental floss 3 is supported to prevent disintegration into the end parts 1a and 1b, preferably using, for example, rivets 21.

In a fifth preferred embodiment of the invention, the dental floss product is packaged according to FIGS. 10, 15, 16, and 17 in protective package 5 which protects the dental floss 3.

Protective package 5 of the dental floss product is provided with a splicing zone 5c which is in the width direction substantially on the centerline of the protective package 5 and substantially the entire width of its dental floss product, preferably, for example, along the entire center line on one or both sides without, however, cutting through the package and thus damaging the underlying floss 3 operating part.

In a sixth preferred embodiment of the invention, the unpackaged dental floss product cut from the product web 22 is packaged in an easily tearable protective shell, for example, made of paper, which may also be arranged to be torn in half. After posting the cover, the protected dental floss product is ready for use. This product solution can also be delivered loose or also, for example, folded, such as an unpackaged dental floss product in the previous embodiment.

A seventh preferred embodiment of the invention is, according to FIG. 14, to replace the notch 2e with a fold 2h made in the preferred direction to guide the dental floss 3 in the middle of the web. The fold 2h made in the preferred direction straightens as it passes between the rollers after the fixing of the dental floss 3. The small fold according to FIG. 14 can also be used to replace the notch 2e in the joining zone and the cut 2f can be replaced by perforation.

Embodiment 5 of the invention described above can also be provided with at least one toothpick of suitable length. The toothpick is removed in connection with the removal of the cover.

Embodiments 3, 5, and 6 of the invention described above are suitable for dental floss products which are intended to be carried, for example, in a pocket or handbag or a telephone case, or which may be available in a restaurant for meals or in a hotel room bathroom next to a toothbrush. In these embodiments, the dental floss product is an individually packaged product in which the dental floss is inside the shield, thereby remaining completely hygienic before use.

Thus, the dental floss product of embodiments 1, 2, and 3 of the invention need not be packaged in protected packages as described above but may preferably be packaged in the same form and condition as in FIG. 9 or 12, such as a bag, case, box or the like.

In embodiments 1-6, it is possible to detach the dental floss product from the product web 22 already as part of the manufacture, or the removal from the pleated or otherwise suitably packaged product web 22 may be left to the user, however, dental floss is cut on the cutting lines (19a, 19b) with perforation at the end of manufacturing.

It is also clear to a person skilled in the art that the splicing zone 5c of protective package 5 can be realized in some other way than by extraction. It can be, for example, thinning by cutting or perforation, but, not through a line or other similar line.

It is also clear to a person skilled in the art that the joint zone of the plate web can be realized in some other way than by cutting. It can be, for example, extraction, thinning by cutting or perforation, or other similar lines.

It is also clear to a person skilled in the art that one or more tapes can be used instead of the adhesive 6 and protective package 5 made of cardboard.

It is also clear to a person skilled in the art that to speed up the manufacture, both plate web 2 can rotate about its longitudinal axis, and the dental floss guide ring 20 can rotate around plate web 2 in the opposite direction at the same time. PATENT CLAIMS

1. A method of manufacturing a dental floss product comprising a single dental floss (3), its guide ring (20) and two sides (2a, 2b), and their connecting joint (2c) forming the plate web (2) comprising notches (2e), around which the dental floss (3) is placed step by step by feeding the dental floss (3) through the guide ring (20) from the side of the plate web (2) and either rotating the guide ring (20) around the plate web (2) or rotating the web plate (2) around its longitudinal axis or rotating both in opposite directions at the same time and between these rotations the plate web (2) and/or the guide ring (20) moves characteristically in the direction of the longitudinal axis of the plate web (2), characterized in that the dental floss (3) rests on the notches (2e) of the plate web (2) as the dental floss (3) rotates full turns around the plate web (2) and between the rotations the dental floss (3) moves in the longitudinal direction between the sides (2a, 2b) of the plate web (2).

2. A dental floss product comprising a single dental floss (3), end portions (1a, 1b), two sides (1c, 1d), and their connecting joint (1f) forming the folded plate (1) comprising fastening zones (4a, 4b), joining zone (4c) and notches (1e), around which the dental floss (3) is placed characterized in that the dental floss (3) passes from the notch (1e) to the next notch (1e) of the folded plate (1) between the sides (1c, 1d) of the folded plate (1).

3. A method of manufacturing a dental floss product according to claim 1, characterized in that the guide ring (20) of the dental floss (3) moves from the notch (2e) to the next notch (2e) of the plate web (2) in the longitudinal direction of the plate web (2), inside the triangle bounded by the joint (2c) of the first side (2a) and the second side (2b) of the plate web (2) and their outer edges (2i, 2j).

4. A method of manufacturing a dental floss product according to claim 1, characterized in that the manufacturing process comprises immersion of the dental floss (3) into the product web (22) and/or protective package (5) at least in part.

5. A method of manufacturing a dental floss product according to claim 1, characterized in that the dental floss product made of the plate web (2) and the dental floss (3) has holes (2g) and/or cuts (2d) in its end portions (1a, 1b) to which the dental floss (3) is arranged to be attached at both ends.

6. A method of manufacturing a dental floss product according to claim 1, characterized in that the plate web (2) passes through a tubular shaft (7) or a tubular shaft (38) carrying the dental floss roll (34) or both the plate web (2) and the dental floss (3) pass through a tubular shaft (37).

7. A method of manufacturing a dental floss product according to claim 1, characterized in that the position of the guide ring (20) of the dental floss (3) moves back and forth to follow the changing position of the notches (2e) in the plate web (2) caused by the rotation back and forth about its longitudinal axis causing a change in the length of the plate web (2).

8. A method of manufacturing a dental floss product according to claim 1, characterized in that when the dental floss (3) is fastened around the plate web (2), with the aid of pre-rotation the straight, non-twisting plate web (2) rotates about its longitudinal axis in one direction less than the dental floss (3) rotates in one direction.

9. A method of manufacturing a dental floss product according to claim 1, characterized in that to a part of the plate web (2), aligned with the splicing zone (5c) will be made a cut (2f) making it easier to tear in half and/or to the protective package (5), on the side of the notch (2e), aligning with the splicing zone (5c), will be made a cut (5d) and/or at least on one side of the protective package (5) a crease (5e) is done to make it easier to tear in half.

10. A dental floss product according to claim 2, characterized in that the dental floss (3) keeps the sides (1c, 1d) of the folded plate (1) against each other or at least the parts under the dental floss (3).

11. A dental floss product according to claim 2, characterized in that the dental floss (3) rotates around the folded plate (1) in the fastening zones (4a, 4b) of the folded plate (1) less than in the joining zone (4c) of the folded plate (1).

12. A dental floss product according to claim 2, characterized in that protective package (5) contains information about the dental floss product, such as the thickness of the dental floss (3) contained in the product or other information provided by the manufacturer.

13. A dental floss product according to claim 2, characterized in that at least one of the surfaces of the protective package (5) is rough and/or has protrusions.

14. A dental floss product according to claim 2, characterized in that the joining zone (4c) of the folded plate (1) stores an operational part of the dental floss (3), of 5-25 cm, preferably 7-13 cm.

15. A dental floss product according to claim 2, characterized in that both sides of the dental floss (3) against the folded plate (1) have an equal number of parts on the sides (1c, 1d) of the folded plate (1).

16. A dental floss product according to claim 2, characterized in that the dental floss (3) is cut on the cutting lines (19a, 19b), and the dental floss products are packaged as a web having at least two dental floss products fixed together.

17. A dental floss product according to claim 2, characterized in that the dental floss product is packaged in a separate package provided with an extraction hole.

18. A dental floss product according to claim 2, characterized in that after folding the size of the folded plate (1) is 5-30 mm×10-60 mm preferably 13-20 mm×30-40 mm.

19. A dental floss product according to claim 2, characterized in that the size of the protective package (5) in which the unpacked dental product is packaged is 8-33 mm×13-63 mm preferably 16-23 mm×33-43 mm.

20. A dental floss product according to claim 2, characterized in that the shape of the protective package (5) in which the unpacked dental product is packaged, is a relief or a 3D figure.
